(19) United States
(12) Patent Application Publication
(10) Pub. No.: US 2023/0095489 A1
(43) Pub. Date: Mar. 30, 2023

(54) DUST COLLECTION DEVICE

(71) Applicant: MITSUBISHI HEAVY INDUSTRIES, LTD., Tokyo (JP)

(72) Inventors: Saneyuki GOYA, Tokyo (JP); Junichiro MIYAGAKI, Tokyo (JP); Jiro YONEDA, Tokyo (JP); Yoshinao KOMATSU, Tokyo (JP); Koki ITO, Tokyo (JP)

(21) Appl. No.: 17/894,420

(22) Filed: Aug. 24, 2022

(30) Foreign Application Priority Data
Sep. 29, 2021 (JP) 2021-159193

(51) Int. Cl. B23K 26/142; B23K 26/14

(52) U.S. Cl. CPC B23K 26/142; B23K 26/1438

(57) ABSTRACT

An object of the disclosure is to improve processing performance. Another object of the disclosure is to improve a working environment and reduce a failure of a processing apparatus. The processing apparatus includes a processing stage on which a composite material is set, a laser head that emits a laser beam in a predetermined direction to the composite material set on the processing stage, a blow off unit that blows off a shield gas to an irradiation point irradiated with the laser beam by the laser head, and an intake unit that takes in the shield gas blown from the blow off unit. The blow off unit and the intake unit are provided so as to interpose the irradiation point and face each other in a first intersecting direction and cause the shield gas to flow in one direction.

### CROSS-REFERENCE TO RELATED APPLICATIONS

This application claims the benefit of priority to Japanese Patent Application Number 2021-159193 filed on Sep. 29, 2021. The entire contents of the above-identified application are hereby incorporated by reference.

### BACKGROUND

### 1. Technical Field

The present disclosure relates to a dust collection device.

### 2. Description of Related Art

Composite materials ,for example, a thermosetting carbon fiber reinforced plastic (CFRP) may be used for aircraft components such as a fuselage and a main wing of an aircraft. To process such a thermosetting composite material into a desired shape, a method of irradiating a composite material with a laser beam to apply processing is known (for example, Japanese Patent Application Laid-Open No. H2-142696).

Japanese Patent Application Laid-Open No. H2-142696 discloses a laser beam machine in which a laser processing head is provided to the tip of an inverted L-shaped laser beam machine column overhanging and extending on a movable horizontal processing stage. The laser beam machine processes a workpiece set on the processing table partitioned on the movable horizontal processing stage. The laser beam machine has an air nozzle arranged at suitable intervals on the inner circumference of the table. Above the table, an air curtain is formed to three-dimensionally surround a table opening and a dust absorption port of a dust collector.

Japanese Patent Application Laid-Open No. H2-142696 is an example of the related art.

### BRIEF SUMMARY

However, in the device of Japanese Patent Application Laid-Open No. H2-142696, the gas flow inside the processing apparatus is complex in the air curtain covering four directions of an object to be processed. Thus, a circulation flow may occur, and local scattering or congestion may occur. If gas congestion or the like occurs, dust or the like will not be suitably removed to cause an adverse effect such as laser interference with dust in laser processing. This may cause a reduction in the processing performance. Further, scattered dust may cause deterioration of the working environment or may cause a failure of the processing apparatus.

Further, use of the curtain covering four directions increases the number of components and may increase the initial cost. Further, the amount of gas flow of the entire processing apparatus increases, and the running cost may increase.

The present disclosure has been made in view of such circumstances, and an object of the present disclosure is to provide a dust collection device that can improve the processing performance.

Another object of the present disclosure is to provide a dust collection device that can improve a working environment or reduce a failure of the dust collection device.

To achieve the above objects, a dust collection device of the present disclosure employs the following solution.

The dust collection device according to one aspect of the present disclosure includes: a blow off unit configured to blow off a shield gas to an irradiation point irradiated with a laser beam by an irradiation unit that emits the laser beam in a predetermined direction to an object to be processed set on a processing stage; and an intake unit configured to take in the shield gas blown from the blow off unit, the blow off unit and the intake unit are provided so as to interpose the irradiation point and face each other in a first intersecting direction that intersects the predetermined direction, and the blow off unit and the intake unit cause the shield gas to flow in one direction.

According to the present disclosure, it is possible to improve the processing performance.

Further, according to the present disclosure, it is possible to improve the working environment or reduce a failure of the dust collection device.

### BRIEF DESCRIPTION OF THE SEVERAL VIEWS OF THE DRAWINGS

FIG. 1 is a front view of a processing apparatus according to a first embodiment of the present disclosure.

FIG. 2 is a perspective view of the processing apparatus according to the first embodiment of the present disclosure.

FIG. 3 is a perspective view of a processing apparatus according to a modified example of the first embodiment of the present disclosure.

FIG. 4 is a perspective view of a processing apparatus according to a second embodiment of the present disclosure.

FIG. 5 is a perspective view of a processing apparatus according to a modified example of the second embodiment of the present disclosure.

FIG. 6 is a front view of a processing apparatus according to a third embodiment of the present disclosure.

FIG. 7 is a perspective view of the processing apparatus according to the third embodiment of the present disclosure.

FIG. 8 is a front view of a processing apparatus according to a fourth embodiment of the present disclosure.

FIG. 9 is a perspective view of the processing apparatus according to the fourth embodiment of the present disclosure.

### DETAILED DESCRIPTION

One embodiment of a dust collection device according to the present disclosure will be described below with reference to the drawings. In the following description, the irradiation direction of a laser beam L is referred to as a Z-axis direction, a direction which is orthogonal to the Z-axis direction and in which a shield gas G flows is referred to as an X-axis direction, and a direction orthogonal to the Z-axis direction and the X-axis direction is referred to as a Y-axis direction.

### First Embodiment

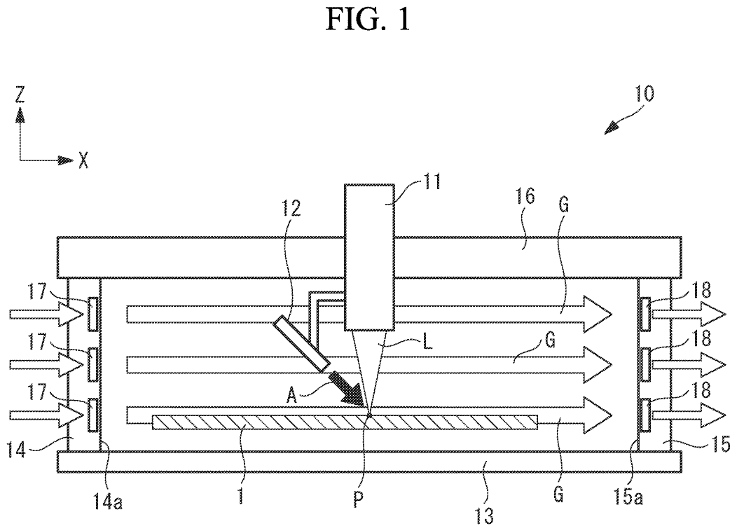

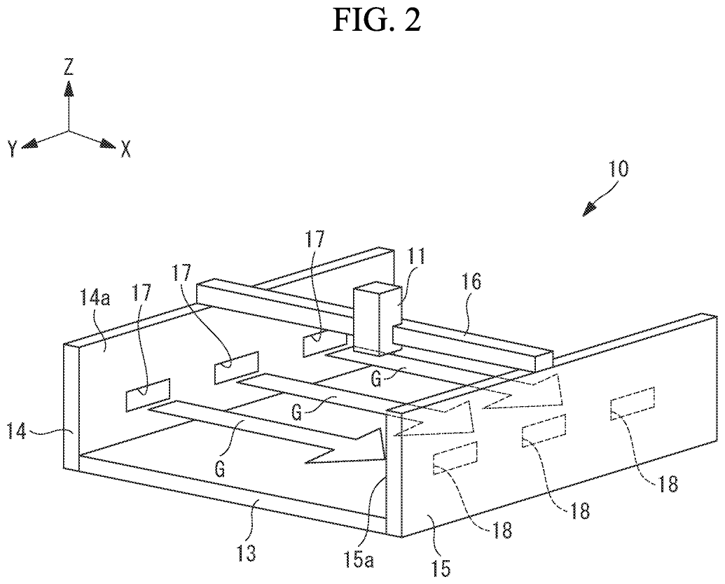

The first embodiment of the present disclosure will be described below with reference to FIG. 1 and FIG. 2. Note that, in FIG. 2, depiction of a composite material 1 is omitted for the purpose of illustration.

A processing apparatus 10 according to the present embodiment is an apparatus that cuts a large composite material (an object to be processed) 1 in order to manufacture an aircraft component forming an aircraft structure. An example of the composite material 1, which is an object to be processed, may be a carbon fiber reinforced plastic (CFRP) in which a thermosetting resin and fibers are compounded, for example. Specifically, the composite material 1 may be a laminated body of multilayered fiber reinforced sheets in which fibers are impregnated with a resin. Note that the composite material 1 may be any composite material 1 in which fibers and a resin are compounded and is not limited to a thermosetting carbon fiber reinforced plastic. For example, the composite material 1 may be a thermoplastic composite material 1. Further, the object to be processed is not limited to a composite material. For example, the dust collection device of the present embodiment may be applied when a metal material or the like is cut.

As illustrated in FIG. 1 and FIG. 2, the processing apparatus 10 includes a leaser head (an irradiation unit) 11 that irradiates the composite material 1 with the laser beam L, an assist gas supply unit (a gas supply unit) 12 that supplies an assist gas A to an irradiation point P, a processing stage 13 on which the composite material 1 is placed, a first wall 14 erected at an end on one side in the X-axis direction of the processing stage 13, a second wall 15 erected at an end on the other side in the X-axis direction of the processing stage 13, and a support unit (a moving unit) 16 that connects the upper ends of the first wall 14 and the second wall 15 to each other and movably supports the laser head 11. The processing apparatus 10 cuts the plate-like composite material 1 placed on the processing stage 13 along a cutting line. In the present embodiment, the cutting line is a line extending in the Y-axis direction, for example.

The laser beam L output from a laser oscillator (not illustrated) is guided to the laser head 11. The laser beam L may be a continuous-wave laser beam or may be a pulsed-wave laser beam.

The laser head 11 emits the laser beam L in the Z-axis direction (a predetermined direction). The laser head 11 irradiates the irradiation point P (a focal point at which the laser beam L converges) with the laser beam L. The irradiation point P is provided on the cutting line. The laser head 11 irradiates the surface of the composite material 1, which is a member to be processed, with the laser beam L to process the composite material 1. Specifically, the composite material 1 is irradiated with the laser beam L, and thereby the composite material 1 is cut along the cutting line. The laser head 11 can move the irradiation point P in the Z-axis direction. The method for moving the irradiation point P is not particularly limited. For example, the laser head 11 itself may move in the Z-axis direction to move the irradiation point P, or the focal point of the laser beam L may be shifted to move the irradiation point P.

The assist gas supply unit 12 is fixed to the laser head 11 via an L-shape bracket. The assist gas supply unit 12 is provided adjacent to one side in the X-axis direction of the laser head 11. As illustrated in FIG. 1, the assist gas supply unit 12 ejects the assist gas A (for example, air or an inert gas) to the irradiation point P for preventing oxidation or assisting a cutting operation. The assist gas supply unit 12 is a cylindrical member, and the assist gas A flows therein.

The direction of the assist gas supply unit 12 in which the assist gas A is ejected is angled so as to form a predetermined angle relative to the surface of the composite material 1. In other words, the assist gas supply unit 12 is arranged so as to form a predetermined angle relative to the surface of the composite material 1.

The processing stage 13 is a planar member, and the composite material 1 is placed on the top face thereof.

The lower end of the first wall 14 is fixed to the processing stage 13. Blow off units 17 described later are provided in an inside face 14a of the first wall 14.

The lower end of the second wall 15 is fixed to the processing stage 13. Intake units 18 described later are provided in an inside face 15a of the second wall 15. The first wall 14 and the second wall 15 face each other.

The support unit 16 is a long member extending in the X-axis direction. The end in the X-axis direction of the support unit 16 is supported on the top face of the first wall 14. Further, the end in the X-axis direction of the support unit 16 is supported on the top face of the second wall 15.

The support unit 16 is supported by the first wall 14 and the second wall 15 movably in the Y-axis direction. The laser head 11 is supported by the support unit 16. The laser head 11 is supported by the support unit 16 movably in the X-axis direction.

The dust collection device is provided to the first wall 14 and the second wall 15. The dust collection device collects dust occurring when the composite material 1 is cut. The dust collection device has the blow off units 17 and the intake units 18.

The blow off units 17 are provided in the inside face 14a of the first wall 14. Each blow off unit 17 has a blow off port from which the shield gas G is blown. The blow off port has a slit shape that is longer in the Y-axis direction. For example, the blow off units 17 blow the shield gas G from the blow off ports in a planar manner as with an air curtain. In detail, the blow off units 17 blow off the shield gas G to form an XY plane. The blow off unit 17 blows off the shield gas to the irradiation point P irradiated with a laser beam by the laser head 11.

A plurality of blow off units 17 are provided. As illustrated in FIG. 2, the plurality of blow off units 17 are aligned at predetermined intervals in the Y-axis direction. Note that the plurality of blow off units 17 may be aligned at predetermined intervals in the Z-axis direction, as illustrated in FIG. 1. Further, the number of rows may be one in the Z-axis direction, as illustrated in FIG. 2.

Further, the processing apparatus 10 includes an air blower (not illustrated) that guides the shield gas G to the blow off units 17. The fan device is not particularly limited and may be, for example, a compressor or a fan. Further, the fan device is connected to the blow off units 17 through a duct or a tube. The duct or the tube may be arranged along the first wall 14.

The intake units 18 are provided in the inside face 15a of the second wall 15. Each intake unit 18 has an intake port from which the shield gas G is taken in. The shape of the intake port may have a slit shape that is longer in the Y-axis direction as with the blow off port, for example. The intake units 18 take in the shield gas G that has blown from the blow off units 17 and passed through the irradiation point P. Further, the intake units 18 take in the assist gas A ejected from the assist gas supply unit 12.

A plurality of intake units 18 are provided. As illustrated in FIG. 2, the plurality of intake units 18 are aligned at predetermined intervals in the Y-axis direction. Note that the plurality of intake units 18 may be aligned at predetermined intervals in the Z-axis direction, as illustrated in FIG. 1. Further, the number of rows may be one in the Z-axis direction, as illustrated in FIG. 2.

Each blow off unit 17 and each intake unit 18 are provided so as to interpose the irradiation point P and face each other in the X-axis direction. In detail, the blow off ports of the blow off units 17 and the corresponding intake ports of the intake units 18 are provided so as to face each other.

Further, the processing apparatus 10 includes a dust collector (not illustrated) that collects the shield gas G and dust taken in by the intake units 18. The fan device sucks the shield gas G and the like. Further, the dust collector is connected to the intake units 18 through a duct or a tube. The duct or the tube may be arranged along the second wall 15.

The intake rate at the intake units 18 is greater than or equal to the sum of the flow rate of the shield gas G blown from the blow off units 17 and the flow rate of the assist gas A ejected from the assist gas supply unit 12. Thus, Q1+Q2≤Q3 is satisfied, where Q1 denotes the flow rate of the shield gas G blown from the blow off units 17, Q2 denotes the flow rate of the assist gas A ejected from the assist gas supply unit 12, and Q3 denotes the intake rate at the intake unit 18. Accordingly, the inside of the processing apparatus 10 (the space where the composite material 1 is set) can be at a negative pressure.

Next, a method of cutting the composite material 1 using the processing apparatus 10 will be described.

First, the laser beam L is emitted by the laser head 11 so as to follow the cutting line on the composite material 1. Thus, the laser beam L is emitted so that the irradiation point P is at a position overlapping the cutting line. Next, the cutting line is scanned by the laser beam L. As a result, the composite material 1 can be cut.

Further, at the same time as the emission of the laser beam L to the composite material 1, the assist gas A is ejected by the assist gas supply unit 12 to the portion irradiated with the laser beam L (at and/or near the irradiation point P).

Further, the blow off units 17 and the intake units 18 operate at the same time as emission of the laser beam L to the composite material 1. Note that, if the apparatus becomes large with a large distance between the blow off units 17 and the intake units 18, there may be a time delay until intake operation is started, and therefore, the blow off units 17 and the intake units 18 may be continuously operated.

According to the present embodiment, the following effects and advantages are achieved.

In the present embodiment, the blow off units 17 and the intake units 18 are provided so as to interpose the irradiation point P and face each other in the X-axis direction. Accordingly, the shield gas G blown from the blow off units 17 passes through the irradiation point P and is taken in the intake units 18. Therefore, dust (for example, fumes) occurring due to irradiation of the composite material 1 with the laser beam L can be removed from the irradiation point P by the shield gas G. Thus, since the adverse effect caused by dust can be reduced, the processing performance of the processing apparatus 10 can be improved.

Further, since dust removed from the irradiation point P is collected by the intake units 18, dust retaining in the processing apparatus 10 can be reduced. Therefore, since the adverse effect caused by dust can be further reduced, the processing performance of the processing apparatus 10 can be further improved. Further, since dust retaining in the processing apparatus 10 can be reduced, the working environment can be improved. Further, a failure of the processing apparatus 10 can be reduced.

Further, since the blow off units 17 and the intake units 18 are provided so as to interpose the irradiation point P and face each other in the X-axis direction, the flow of the shield gas G can be formed in one direction (the X-axis direction). In such a way, the flow of the shield gas G can be straightened in one direction. Accordingly, since it is possible that the flow of the shield gas G is less likely to form a circulation flow, dust retaining in the processing apparatus can be reduced. Therefore, since the adverse effect caused by dust can be further reduced, the processing performance of the processing apparatus 10 can be further improved.

Further, the blow off units 17 and the intake units 18 are provided so as to interpose the irradiation point P and face each other in the X-axis direction. Thus, the blow off units 17 and the intake units 18 are provided in only the X-axis direction. Accordingly, the structure can be simplified compared to a case where the blow off units 17 and the like are provided so as to surround four directions about the irradiation point P, for example. Therefore, the initial cost can be reduced. Further, since the required flow amount of the shield gas G can be reduced, the running cost can be reduced.

Further, in the present embodiment, the assist gas supply unit 12 that supplies the assist gas A is provided.

Accordingly, the shield gas G blown from the blow off units 17 and the assist gas A supplied from the assist gas supply unit 12 flow inside the processing apparatus 10.

In the present embodiment, the intake rate at the intake units 18 is greater than or equal to the sum of the flow rate of the shield gas G blown from the blow off units 17 and the flow rate of the assist gas A supplied from the assist gas supply unit 12. This enables suitable intake of the shield gas G and the assist gas A. It may therefore be possible to avoid a situation where dust leaks out of the processing apparatus 10 from a part other than the intake units 18 and improve reliability of dust collection.

Further, in the present embodiment, the blow off port of the blow off unit 17 has a slit shape. Accordingly, the shield gas G can be blown in a planar manner. Therefore, dust can be more easily removed.

[Modified Example 1]

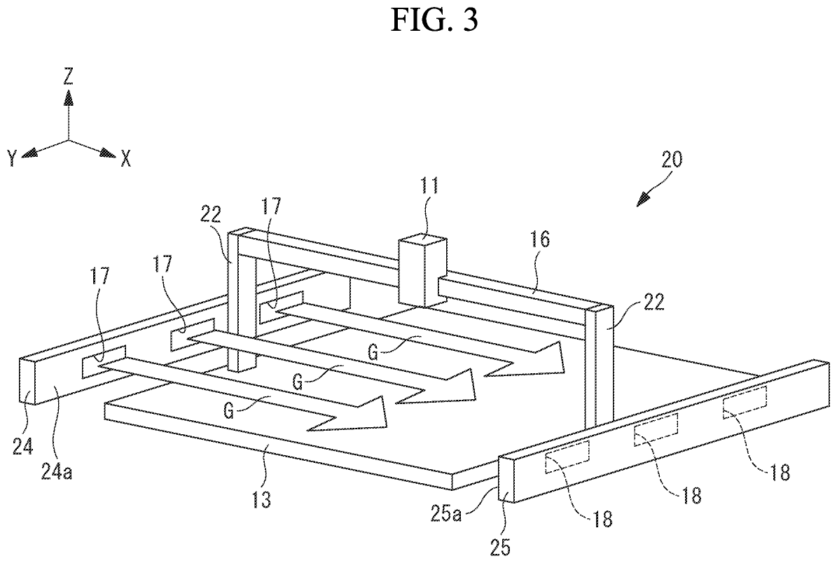

Next, a modified example of the present embodiment will be described with reference to FIG. 3. The present modified example differs from the first embodiment in that a pair of support legs 22, a first stand 24, and a second stand 25 are provided instead of the first wall 14 and the second wall 15. Since other features are the same as those in the first embodiment, the same features are labeled with the same references, and the detailed description thereof will be omitted.

In the support unit 16 of a processing apparatus 20 according to the present modified example, one end in the X-axis direction is fixed to the upper end of one of the pair of support legs 22. Further, in the support unit 16, the other end in the X-axis direction is fixed to the upper end of one of the pair of support legs 22. Thus, the support unit 16 is provided so that the upper ends of the pair of support legs 22 are connected to each other.

Each support leg 22 is a long member extending in the Z-axis direction. Each support leg 22 is supported on the processing stage 13 movably in the Y-axis direction. In details, one of the pair of support legs 22 is supported by one end in the X-axis direction of the processing stage 13. Further, the other of the pair of support legs 22 is supported by the other end in the X-axis direction of the processing stage 13.

Further, the processing apparatus 20 includes the first stand 24 provided on one end side in the X-axis direction from the processing stage 13 and a second stand 25 provided on the other end side in the X-axis direction from the processing stage 13. A plurality of blow off units 17 are provided in the inside face 24a of the first stand 24. The plurality of blow off units 17 are aligned at predetermined intervals in the Y-axis direction. A plurality of intake units 18 are provided in the inside face 25a of the second stand 25. The plurality of intake units 18 are aligned at predetermined intervals in the Y-axis direction.

Each blow off unit 17 and each intake unit 18 are provided so as to interpose the irradiation point P and face each other in the X-axis direction. In detail, the blow off ports of the blow off units 17 and the corresponding intake ports of the intake units 18 are provided so as to face each other.

According to the present modified example, the same advantageous effects as those in the first embodiment described above are achieved.

### Second Embodiment

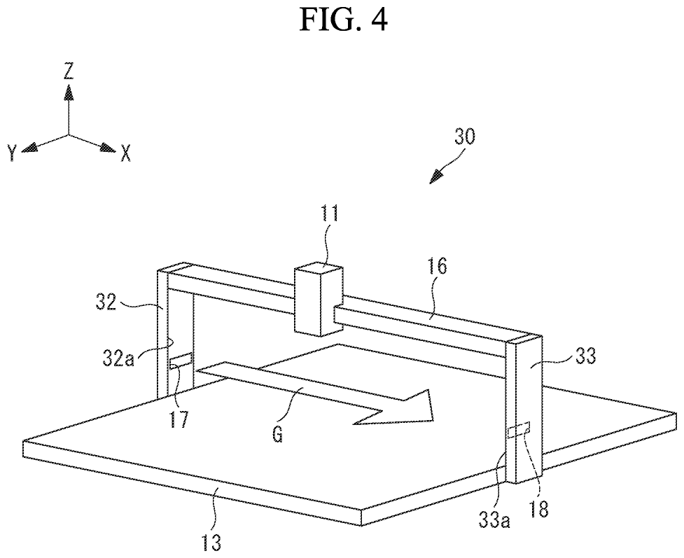

Next, the second embodiment of the present disclosure will be described with reference to FIG. 4. The present embodiment differs from the first embodiment in that a first support leg 32 and a second support leg 33 are provided instead of the first wall 14 and the second wall 15. Since other features are the same as those in the first embodiment, the same features are labeled with the same references, and the detailed description thereof will be omitted.

In the support unit 16 of a processing apparatus 30 according to the present embodiment, one end in the X-axis direction is fixed to the upper end of the first support leg (a moving unit) 32. Further, in the support unit 16, the other end in the X-axis direction is fixed to the upper end of the second support leg (a moving unit) 33.

The first support leg 32 and the second support leg 33 are long members extending in the Z-axis direction. The first support leg 32 and the second support leg 33 are supported by the processing stage 13 movably in the Y-axis direction. In detail, the first support leg 32 is supported by one end in the X-axis direction of the processing stage 13. Further, the second support leg 33 is supported by the other end in the X-axis direction of the processing stage 13.

The blow off unit 17 is provided in the inside face 32a of the first support leg 32. Further, the intake unit 18 is provided in the inside face 33a of the second support leg 33.

The blow off unit 17, the intake unit 18, and the laser head 11 are arranged such that the positions thereof in the Y-axis direction are the same. The blow off unit 17 and the intake unit 18 are provided so as to interpose the irradiation point P and face each other in the X-axis direction.

According to the present embodiment, the following effects and advantages are achieved.

In the present embodiment, the laser head 11 is provided on the first support leg 32 and the second support leg 33. Accordingly, the first support leg 32 and the second support leg 33 move in the Y-axis direction, and thereby the laser head 11 also moves. Further, in the present embodiment, the blow off unit 17 and the intake unit 18 are provided to the first support leg 32 and the second support leg 33 that move in the Y-axis direction. Accordingly, the first support leg 32 and the second support leg 33 move in the Y-axis direction, and thereby the blow off unit 17 and the intake unit 18 also move. Therefore, even when the laser head 11 moves in the Y-axis direction, the blow off unit 17 and the intake unit 18 also move together with the laser head 11. Thus, the shield gas G can be accurately blown to the irradiation point P, and dust removed by the shield gas G can be collected.

Further, for example, it may be considered that a plurality of blow off units 17 and intake units 18 are aligned in the Y-axis direction to cover the movement of the laser head 11. However, the required flow amount of the shield gas G can be reduced compared to such a configuration.

[Modified Example 2]

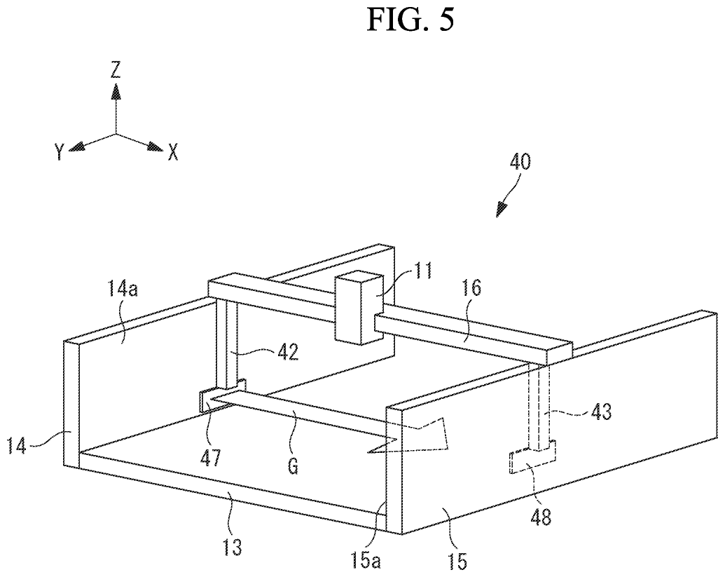

Next, a modified example of the present embodiment will be described with reference to FIG. 5. The present modified example differs from the first embodiment in that neither blow off unit 17 nor intake unit 18 is provided in the first wall 14 or the second wall 15. Further, the present modified example differs from the first embodiment in that a first support bar 42 and a second support bar 43 are provided. Since other features are the same as those in the first embodiment, the same features are labeled with the same references, and the detailed description thereof will be omitted.

A processing apparatus 40 according to the present modified example includes the first support bar 42 extending downward from the under face of one end in the X-axis direction of the support unit 16 and the second support bar 43 extending downward from the under face of the other end in the X-axis direction of the support unit 16. The first support bar 42 and the second support bar 43 are fixed to the support unit 16.

The first support bar 42 and the second support bar 43 are long members extending linearly in the Z-axis direction. The first support bar 42 and the second support bar 43 are provided inside the first wall 14 and the second wall 15. A blow off unit 47 is fixed to the lower end of the first support bar 42. Further, an intake unit 48 is fixed to the lower end of the second support bar 43.

The blow off unit 47, the intake unit 48, and the laser head 11 are arranged such that the positions thereof in the Y-axis direction are the same. The blow off unit 47 and the intake unit 48 are provided so as to interpose the irradiation point P and face each other in the X-axis direction.

According to the present modified example, the same advantageous effects as those in the second embodiment described above are achieved.

[Modified Example 3]

Next, a modified example of the present embodiment will be described. The present modified example differs from the above first embodiment in that a control device (not illustrated) is provided.

The control device (control unit) controls activation and deactivation of the blow off units 17 and the intake units 18. In detail, in response to the movement in the Y-axis direction of the laser head 11, the control device activates the blow off unit 17 and the intake unit 18 which are aligned in the X-axis direction with respect to the laser head 11 and deactivates other blow off units 17 and intake units 18.

The control device may have a detection unit that detects the laser head 11 and control activation and deactivation of the blow off units 17 and the intake units 18 based on the detection result from the detection unit. Further, the control device may control activation and deactivation of the blow off units 17 and the intake units 18 in accordance with control information on the laser head 11. Further, when an operation program of the laser head 11 is known in advance, the control device may control activation and deactivation of the blow off units 17 and the intake units 18 in accordance with the program.

For example, the control device is formed of a central processing unit (CPU), a random access memory (RAM), a read only memory (ROM), a computer readable storage medium, and the like. Further, a series of processes for implementing various functions are stored in the storage medium or the like in a form of a program as an example, and various functions are implemented when the CPU reads such a program to the RAM or the like and performs modification or operational processing on information. Note that an applicable form of the program may be a form in which a program is installed in advance in a ROM or another storage medium, a form in which a program is provided in a state of being stored in a computer readable storage medium, a form in which a program is delivered via a wired or wireless communication scheme, or the like. The computer readable storage medium may be a magnetic disk, a magneto-optical disk, a CD-ROM, a DVD-ROM, a semiconductor memory, or the like.

Note that the configuration of the control device is not limited to the configuration described above.

According to the present modified example, the following effects and advantages are achieved.

In the present modified example, even when the laser head 11 moves in the Y-axis direction, the shield gas G can be accurately blown to the irradiation point P, and dust removed by the shield gas G can be collected. Thus, dust retaining in the processing apparatus can be reduced.

Further, the required flow amount of the shield gas G can be reduced compared to a case where all the plurality of blow off units 17 and intake units 18 are activated.

### Third Embodiment

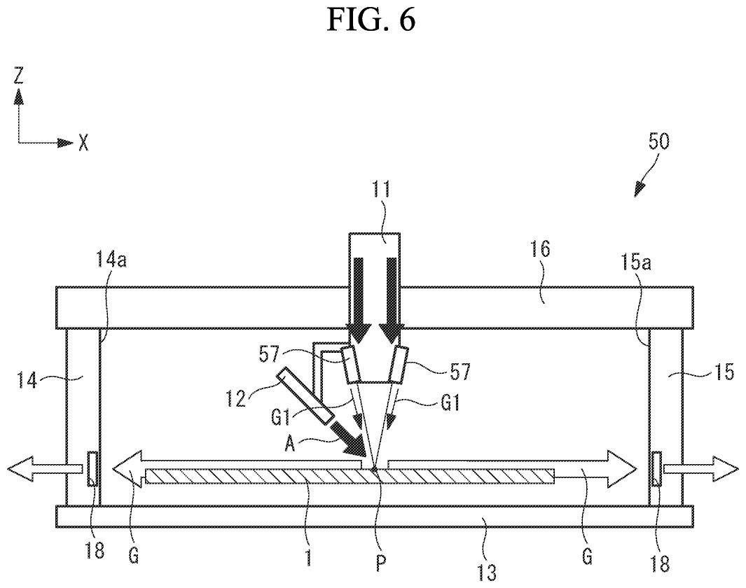

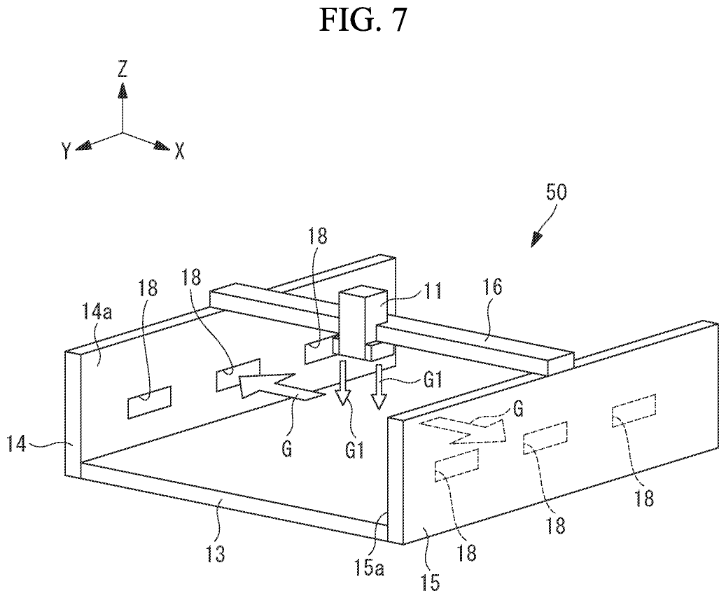

Next, the third embodiment of the present disclosure will be described with reference to FIG. 6 and FIG. 7. The present embodiment differs from the first embodiment in that the blow off units 17 are provided adjacent to the laser head 11. Further, the present embodiment differs from the first embodiment in that the intake units 18 are provided instead of the blow off units 17 in the first wall 14. Since other features are the same as those in the first embodiment, the same features are labeled with the same references, and the detailed description thereof will be omitted.

A processing apparatus 50 according to the present embodiment includes a pair of blow off units 57. Each blow off unit 57 is provided adjacent to the laser head 11 and blows off the shield gas G1 in the Z-axis direction. In detail, the pair of blow off units 57 are fixed on both sides in the X-axis direction of the laser head 11. The blow off port of each blow off unit 57 has a slit shape that is longer in the Y-axis direction. Note that the number of blow off units 57 may be one.

Each blow off unit 57 is angled at a predetermined angle relative to the perpendicular direction. Each blow off unit 57 blows the shield gas G1 toward a part at and near the irradiation point P. In detail, the shield gas G1 is blown so that the shield gases G1 blown in a planar manner reach the irradiation point P from both sides.

According to the present embodiment, the following effects and advantages are achieved.

In the present embodiment, the shield gas G1 blown from the blow off units 57 hits the composite material 1. The shield gas G1 that has hit the composite material 1 removes dust or the like occurring at the irradiation point P. The shield gas G1 that has removed dust or the like hits the composite material 1, thereby changes the flow direction to the X-axis direction, flows in the X-axis direction, and is taken in the intake units 18 (see the arrows G). Therefore, dust can be removed from the irradiation point P and collected by the intake units 18.

Further, in the present embodiment, the blow off units 57 are provided adjacent to the laser head 11 and blow off the shield gas G in the Z-axis direction. Accordingly, the shield gas can be accurately blown to the laser head 11. Therefore, dust can be suitably removed and collected.

In particular, since the shield gas G1 is ejected from the blow off unit 57 in a planar manner (in a ZY-planar manner), the blown shield gas G1 is less likely to move in the Y-axis direction. Therefore, it is easy to cause the shield gas G to flow in the X-axis direction. Therefore, the shield gas G can be suitably guided to the intake units 18.

### Fourth Embodiment

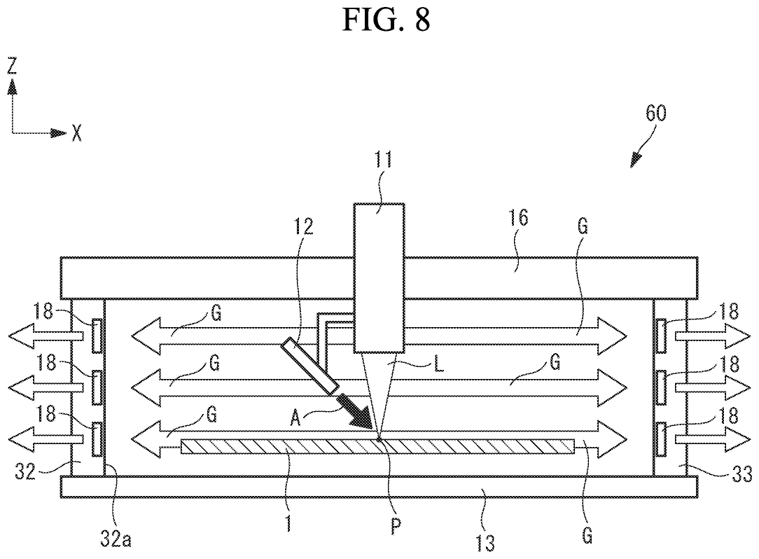

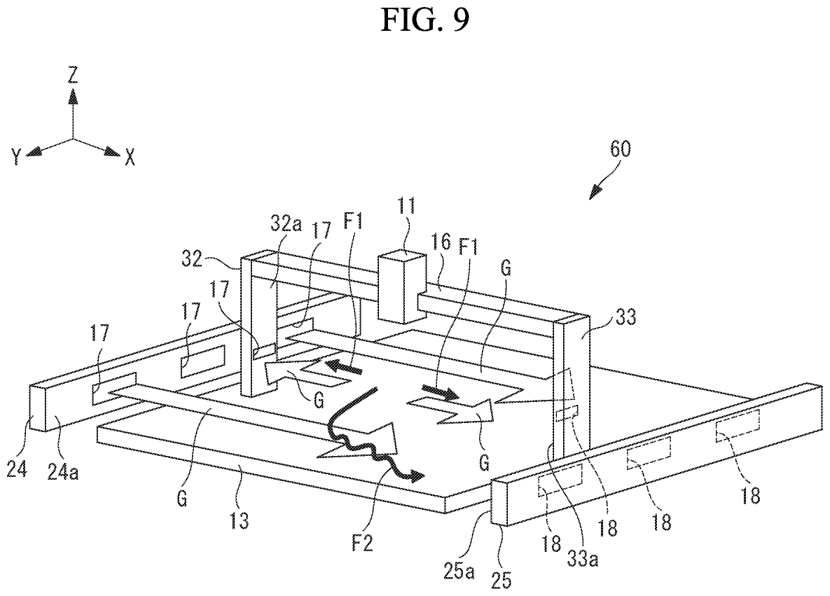

Next, the fourth embodiment of the present disclosure will be described with reference to FIG. 8 and FIG. 9. The present embodiment differs from the first embodiment (Modified example 1) in that the first support leg 32 and the second support leg 33 are provided instead of the pair of support legs 22. Since other features are the same as those in the modified example of the first embodiment, the same features are labeled with the same references, and the detailed description thereof will be omitted.

In a processing apparatus 60 according to the present embodiment, one end in the X-axis direction is fixed to the upper end of the first support leg (moving unit) 32. Further, in the support unit 16, the other end in the X-axis direction is fixed to the upper end of the second support leg (moving unit) 33.

The first support leg 32 and the second support leg 33 are long members extending in the Z-axis direction. The first support leg 32 and the second support leg 33 are supported by the processing stage 13 movably in the Y-axis direction. In detail, the first support leg 32 is supported by one end in the X-axis direction of the processing stage 13.

The second support leg 33 is supported by the other end in the X-axis direction of the processing stage 13.

The intake unit (a moving intake unit) 18 is provided in the inside face 32a of the first support leg 32. Further, the intake unit (a moving intake unit) 18 is provided in the inside face 33a of the second support leg 33.

The two intake units 18 and the laser head 11 are arranged such that the positions thereof in the Y-axis direction are the same. The two intake units 18 are provided so as to interpose the irradiation point P and face each other in the X-axis direction.

According to the present embodiment, the following effects and advantages are achieved.

In the present embodiment, the pair of intake units 18 that take in the shield gas G are provided so as to interpose the irradiation point P and face each other. Accordingly, a region near the irradiation point P can be an intake region that easily takes in the shield gas G or dust. Therefore, dust can be suitably collected. Thus, dust retaining in the processing apparatus can be reduced.

Further, since the intake units 18 are provided in the first support leg 32 and the second support leg 33, the intake units 18 move as the irradiation point P of the laser beam L moves. Therefore, even when the laser head 11 moves in the second intersecting direction, dust can be suitably collected (see the arrows F1).

Further, the plurality of blow off units 17 and intake units 18 are aligned in the Y-axis direction on one end side and the other end side in the X-axis direction of the processing stage 13. Accordingly, even when dust deflects from the intake region (see the arrow F2), the dust can be guided to the intake units 18 by the shield gas G blown from the blow off units 17. Therefore, dust can be suitably collected. Thus, dust retaining in the processing apparatus 60 can be reduced.

Further, for example, the laser head 11 may move in the X-axis direction in a reciprocating cutting operation or the like. In such a case, the flow directions of the assist gas A and the shield gas G may face each other. If the flow directions of the assist gas A and the shield gas G face each other, dust may be stirred up.

In the present embodiment, however, since the intake units 18 are provided on both sides in the X-axis direction in a region near the irradiation point P, the flow directions of the assist gas A and the shield gas G do not face each other.

Therefore, it may be possible to avoid a situation where dust is stirred up.

Note that the present disclosure is not limited to each embodiment described above, and modifications are possible as appropriate within the scope not departing from the spirit thereof.

For example, although the present disclosure is applied to the processing apparatus that cuts the composite material 1 by a laser beam in each embodiment described above, the present disclosure is not limited thereto. For example, the present disclosure may be applied to a processing apparatus that welds the composite material 1 by a laser beam.

The dust collection device described in the above embodiment is recognized as follows, for example.

The dust collection device according to one aspect of the present disclosure includes: a blow off unit (17) configured to blow off a shield gas (G) to an irradiation point (P) irradiated with a laser beam (L) by an irradiation unit (11) that emits the laser beam in a predetermined direction (the Z-axis direction) to an object to be processed set on a processing stage; and an intake unit (18) configured to take in the shield gas blown from the blow off unit, the blow off unit and the intake unit are provided so as to interpose the irradiation point and face each other in a first intersecting direction (the X-axis direction or the Y-axis direction) that intersects the predetermined direction, and the blow off unit and the intake unit cause the shield gas to flow in one direction.

In the above configuration, the blow off unit and the intake unit are provided so as to interpose the irradiation point and face each other in the first intersecting direction. Accordingly, the shield gas blown from the blow off units passes through the irradiation point and is taken in the intake units. Therefore, dust (for example, fumes) occurring due to irradiation of the composite material with the laser beam can be removed from the irradiation point by the shield gas. Thus, since the adverse effect caused by dust can be reduced, the processing performance can be improved. Further, since dust removed from the irradiation point is collected by the intake units, dust retaining in the processing apparatus can be reduced. Therefore, since the adverse effect caused by dust can be further reduced, the processing performance can be further improved. Further, since dust retaining in the processing apparatus can be reduced, the working environment can be improved. Further, a failure of the processing apparatus can be reduced.

Further, since the blow off units and the intake units are provided so as to interpose the irradiation point and face each other in the first intersecting direction, the flow of the shield gas can be formed in one direction (the first intersecting direction). In such a way, the flow of the shield gas can be straightened in one direction. Accordingly, since it is possible that the flow of the shield gas is less likely to form a circulation flow, dust retaining in the processing apparatus can be reduced. Therefore, since the adverse effect caused by dust can be further reduced, the processing performance can be further improved.

Further, the blow off units and the intake units are provided so as to interpose the irradiation point and face each other in the first intersecting direction. Thus, the blow off units and the intake units are provided in only the first intersecting direction. Accordingly, the structure can be simplified compared to a case where the blow off units and the like are provided so as to surround four directions about the irradiation point, for example. Therefore, the initial cost can be reduced. Further, since the required flow amount of the shield gas can be reduced, the running cost can be reduced.

Further, the dust collection device according to one aspect of the present disclosure includes a moving unit (16, 22) configured to move in a second intersecting direction (the Y-axis direction) that intersects both the predetermined direction and the first intersecting direction with respect to the processing stage and provided with the irradiation unit, and the blow off unit and the intake unit are provided to the moving unit.

In the above configuration, the irradiation unit is provided on the moving unit. Accordingly, the moving unit moves in the second intersecting direction, and thereby the irradiation unit also moves. Further, in the above configuration, the blow off unit and the intake unit are provided to the moving unit that moves in the second intersecting direction. Accordingly, the moving unit moves in the second intersecting direction, and thereby the blow off unit and the intake unit also move. Therefore, even when the irradiation unit moves in the second intersecting direction, the blow off unit and the intake unit also move together with the irradiation unit. Thus, the shield gas can be accurately blown to the irradiation point, and dust removed by the shield gas can be collected.

Further, for example, it may be considered that a plurality of blow off units and intake units are aligned in the second intersecting direction to follow the movement of the irradiation unit. However, the required flow amount of the shield gas can be reduced compared to such a configuration.

Further, the dust collection device according to one aspect of the present disclosure includes: a moving unit configured to move in a second intersecting direction (the Y-axis direction) that intersects both the predetermined direction and the first intersecting direction with respect to the processing stage and provided with the irradiation unit; and a control unit configured to control activation and deactivation of the blow off unit and the intake unit, a plurality of blow off units and intake units are aligned in the second intersecting direction. In response to movement of the irradiation unit, the control unit activates the blow off unit and the intake unit which are aligned with the irradiation unit in the first intersecting direction and deactivates the blow off units and the intake units which are not aligned with the irradiation unit in the first intersecting direction.

In the above configuration, In response to movement of the irradiation unit, the control unit activates the blow off unit and the intake unit which are aligned with the irradiation unit in the first intersecting direction and deactivates the blow off units and the intake units which are not aligned with the irradiation unit in the first intersecting direction. Therefore, even when the irradiation unit moves in the second intersecting direction, the shield gas can be accurately blown to the irradiation point, and dust removed by the shield gas can be collected. Thus, dust retaining in the processing apparatus can be reduced. Further, the required amount flow of the shield gas can be reduced compared to a case where all the plurality of blow off units and intake units are activated.

Further, the dust collection device according to one aspect of the present disclosure includes: a moving unit (16, 32, 33) configured to move the irradiation unit in a second intersecting direction (the Y-axis direction) that intersects both the predetermined direction and the first intersecting direction and provided with the irradiation unit; a first stand (24) provided on one end side in the first intersecting direction from the moving unit and provided with the blow off unit; and a second stand (25) provided on the other end side in the first intersecting direction from the moving unit and provided with the intake unit, a plurality of blow off units and intake units are aligned in the second intersecting direction, and in the moving unit, a pair of moving intake units (18) configured to take in the shield gas are provided so as to interpose the irradiation point and face each other in the first intersecting direction.

In the above configuration, the pair of moving intake units that take in the shield gas are provided so as to interpose the irradiation point and face each other. Accordingly, a region near the irradiation point can be an intake region that easily takes in the shield gas or dust. Therefore, dust can be suitably collected. Thus, dust retaining in the processing apparatus can be reduced.

Further, since the moving intake units are provided in the moving unit, the moving intake units move as the irradiation point of the laser beam moves. Therefore, even when the irradiation unit moves in the second intersecting direction, dust can be suitably collected.

Further, the plurality of blow off units and intake units are aligned in the second intersecting direction on one end side and the other end side in the first intersecting direction of the moving unit. Accordingly, even when dust deflects from the intake region, the dust can be guided to the intake units by the shield gas blown from the blow off units. Therefore, dust can be suitably collected. Thus, dust retaining in the processing apparatus can be reduced.

Further, the dust collection device according to one aspect of the present disclosure includes: a blow off unit (17) configured to blow off a shield gas (G) to an irradiation point (P) irradiated with a laser beam (L) by an irradiation unit (11) that emits the laser beam in a predetermined direction (the Z-axis direction) to the object to be processed set on the processing stage; and a plurality of intake units (18) configured to take in the shield gas blown from the blow off unit, the blow off unit is provided adjacent to the irradiation unit and blows off the shield gas in the predetermined direction, and the plurality of intake units are provided so as to interpose the irradiation point and face to each other in a first intersecting direction that intersects the predetermined direction.

In the above configuration, the shield gas blown from the blow off units hits the composite material. The shield gas that has hit the composite material removes dust or the like occurring at the irradiation point. The shield gas that has removed dust or the like hits the composite material, thereby changes the flow direction to the first intersecting direction, and is taken in the intake units. Therefore, dust can be removed from the irradiation point and collected by the intake units.

Further, in the above configuration, the blow off units are provided adjacent to the irradiation unit and blow off the shield gas in the predetermined direction. Accordingly, the shield gas can be accurately blown to the irradiation unit. Therefore, dust can be suitably removed and collected.

Further, in the dust collection device according to one aspect of the present disclosure, an intake rate at the intake unit is greater than or equal to the sum of a flow rate of the shield gas blown from the blow off unit and a flow rate of an assist gas (A) supplied from an assist gas supply unit (12) that supplies the assist gas in the predetermined direction to the object to be processed.

In the above configuration, the assist gas is provided from the assist gas supply unit. Accordingly, the shield gas blown from the blow off units and the assist gas supplied from the assist gas supply unit flow inside the processing apparatus.

In the above configuration, the intake rate at the intake units is greater than or equal to the sum of the flow rate of the shield gas blown from the blow off units and the flow rate of the assist gas supplied from the assist gas supply unit. This enables suitable intake of the shield gas and the assist gas. It may therefore be possible to avoid a situation where dust leaks out of the processing apparatus from a part other than the intake units and improve reliability of dust collection.

Further, in the dust collection device according to one aspect of the present disclosure, the blow off unit includes a blow off port configured to blow off the shield gas, and the blow off port has a slit shape.

In the above configuration, the blow off port has a slit shape. Accordingly, the shield gas can be blown in a planar manner. Therefore, dust can be easily removed.

### LIST OF REFERENCES

1: composite material
10: processing apparatus
11: laser head (irradiation unit)
12: assist gas supply unit (gas supply unit)
13: processing stage
14: first wall
14a: inside face
15: second wall
15a: inside face
16: support unit (moving unit)
17: blow off unit
18: intake unit
20: processing apparatus
22: support leg
24: first stand
24a: inside face
25: second stand
25a: inside face
30: processing apparatus
32: first support leg (moving unit)
32a: inside face
33: second support leg (moving unit)
33a: inside face
40: processing apparatus
42: first support bar
43: second support bar
50: processing apparatus
60: processing apparatus

What is claimed is:

1. A dust collection device comprising:
a blow off unit configured to blow off a shield gas to an irradiation point irradiated with a laser beam by an irradiation unit that emits the laser beam in a predetermined direction to an object to be processed set on a processing stage; and
an intake unit configured to take in the shield gas blown from the blow off unit,
wherein the blow off unit and the intake unit are provided so as to interpose the irradiation point and face each other in a first intersecting direction that intersects the predetermined direction, and
wherein the blow off unit and the intake unit cause the shield gas to flow in one direction.

2. The dust collection device according to claim 1 further comprising a moving unit configured to move in a second intersecting direction that intersects both the predetermined direction and the first intersecting direction with respect to the processing stage and provided with the irradiation unit,
wherein the blow off unit and the intake unit are provided in the moving unit.

3. The dust collection device according to claim 1 further comprising:
a moving unit configured to move in a second intersecting direction that intersects both the predetermined direction and the first intersecting direction with respect to the processing stage and provided with the irradiation unit; and
a control unit configured to control activation and deactivation of the blow off unit and the intake unit,
wherein a plurality of blow off units and intake units are aligned in the second intersecting direction, and
wherein, in response to movement of the irradiation unit, the control unit activates the blow off unit and the intake unit which are aligned with the irradiation unit in the first intersecting direction and deactivates the blow off units and the intake units which are not aligned with the irradiation unit in the first intersecting direction.

4. The dust collection device according to claim 1 further comprising:
a moving unit configured to move the irradiation unit in a second intersecting direction that intersects both the predetermined direction and the first intersecting direction and provided with the irradiation unit;
a first stand provided on one end side in the first intersecting direction from the moving unit and provided with the blow off unit; and
a second stand provided on the other end side in the first intersecting direction from the moving unit and provided with the intake unit,
wherein a plurality of blow off units and intake units are aligned in the second intersecting direction, and
wherein in the moving unit, a pair of moving intake units configured to take in the shield gas are provided so as to interpose the irradiation point and face each other in the first intersecting direction.

5. A dust collection device comprising:
a blow off unit configured to blow off a shield gas to an irradiation point irradiated with a laser beam by an irradiation unit that emits the laser beam in a predetermined direction to an object to be processed set on a processing stage; and
a plurality of intake units configured to take in the shield gas blown from the blow off unit,
wherein the blow off unit is provided adjacent to the irradiation unit and blows off the shield gas in the predetermined direction, and
wherein the plurality of intake units are provided so as to interpose the irradiation point and face to each other in a first intersecting direction that intersects the predetermined direction.

6. The dust collection device according to claim 1, wherein an intake rate at the intake unit is greater than or equal to a sum of a flow rate of the shield gas blown from the blow off unit and a flow rate of an assist gas supplied from an assist gas supply unit that supplies the assist gas in the predetermined direction to the object to be processed.

7. The dust collection device according to claim 2, wherein an intake rate at the intake unit is greater than or equal to a sum of a flow rate of the shield gas blown from the blow off unit and a flow rate of an assist gas supplied from an assist gas supply unit that supplies the assist gas in the predetermined direction to the object to be processed.

8. The dust collection device according to claim 3, wherein an intake rate at the intake unit is greater than or equal to a sum of a flow rate of the shield gas blown from the blow off unit and a flow rate of an assist gas supplied from an assist gas supply unit that supplies the assist gas in the predetermined direction to the object to be processed.

9. The dust collection device according to claim 4 wherein an intake rate at the intake unit is greater than or equal to a sum of a flow rate of the shield gas blown from the blow off unit and a flow rate of an assist gas supplied from an assist gas supply unit that supplies the assist gas in the predetermined direction to the object to be processed.

10. The dust collection device according to claim 5, wherein an intake rate at the intake unit is greater than or equal to a sum of a flow rate of the shield gas blown from the blow off unit and a flow rate of an assist gas supplied from an assist gas supply unit that supplies the assist gas in the predetermined direction to the object to be processed.

11. The dust collection device according to claim 1,
wherein the blow off unit includes a blow off port configured to blow off the shield gas, and
wherein the blow off port has a slit shape.
